(19) United States
(12) Patent Application Publication
(10) Pub. No.: US 2005/0234958 A1
(43) Pub. Date: Oct. 20, 2005

(54) Iterative collaborative annotation system

(76) Inventors: Michael James Sipusic, Singapore (SG); Tommy Gunnar Nordqvist, Singapore (SG); Xin Yan, Singapore (SG)

Correspondence Address: CONLEY ROSE, P.C., P. O. BOX 3267, HOUSTON, TX, 77253-3267, US

(21) Appl. No.: 10/488,119

(22) PCT Filed: Dec. 7, 2001
(86) PCT No.: PCT/SG01/00248

§ 371 Date: Sep. 23, 2004

(30) Foreign Application Priority Data
Aug. 31, 2001 (WO) PCT/SG01/00174

(51) Int. Cl. G06F 17/00

(52) U.S. Cl. 707/102

(57) ABSTRACT

A collaborative annotation system for facilitating annotations, such as commentaries, of time-based media, such as video, by users is disclosed. The system involves displaying and controlling the display of a time-based medium, and receiving and storing input for defining a location in the time-based medium. The system also involves receiving and storing an annotation relating to the context of the location, and performing and storing a valuation relating to the annotation.

### FIELD OF INVENTION

The invention relates to collaborative annotation systems. In particular, the invention relates to the production of high-level semantic meta-data for time-based media as a by-product of an iterative collaborative annotation system for distributed knowledge sharing in relation to the time-based media.

### BACKGROUND

Traditionally, different analog media have always been associated with different production media. As a result, it is difficult to combine or converge different analog media. For example, it is difficult to combine paintings brushed on canvas, photographs and movies imaged on celluloid, and literature inked on paper. By applying modern digitizing technology whereby the content of these analog media may be digitized and stored digitally, it is now possible to combine the content of these digitized forms into new media genres, hereinafter called “fused media”.

As technologies and business models for supporting media convergence develop, there also arises a pressing need for descriptive methodologies to inventory the vast catalogues of stored digital media archived by major content providers. Because such inventories are large, it may be economically unfeasible to describe the contents of these digital media catalogues manually. This has lead to a need for technologies that automate the analysis of digital media contents. The output of this automation process constitutes a form of meta-data that may provide semantically useful descriptions of the contents of digital media, particularly time-based media. Time-based media is generally defined to be any form of digital media that needs to be viewed/read/heard in a predefined linear sequence for any context in which the digital media or a part thereof is accessed to be meaningful. With such meta-data providing semantically useful descriptions, agents of content providers may then access parts of completed time-based media, and purchase the rights to re-use these media components as resources for building new, fused media.

There are a number of different types of meta-data associated with time-based media as part of fused media. Since the problem is to derive or generate semantically useful meta-data from time-based media like video, such time-based media is hereinafter called primary media. Other media that are combined with the primary media is hereinafter called secondary media. Within the context of fused media, there are two types of meta-data for the primary media, namely intrinsic and extrinsic meta-data. Intrinsic meta-data consists of descriptions of the content of the video that are derived from the primary media, that is, the video of interest. For example, signal processing analysis may be used to locate frames of the video that contain certain colour attributes associated with faces of characters in the video.

Descriptions that are generated from secondary media attached to the primary media are considered extrinsic meta-data. For example, the sound track of the video may be analysed for large increases of volume, which may indicate action sequences in the primary media. Alternatively, the sound track may be converted to text and used as a high-level semantic description of the visual contents of the primary media. Within the fused media context, textual annotations attached to the primary media would be another example of a source of extrinsic meta-data relating to the primary media. In addition, information relating to the history of user interaction with the primary media, while adding no content to the fused media may also have value as a source of extrinsic meta-data relating to the primary media. For example, information relating to the frequency with which viewers watches segments in the primary media or information relating to locations where annotations are attached to the primary media may be useful when other viewers choose whether or not to watch the corresponding video segment. Similarly, viewer ratings of the content may serve as a source of extrinsic metadata.

Regardless of its source, the ultimate goal of extracting or deriving meta-data is to provide an agent with sufficient information to make an accurate decision as to whether the content of the primary media at a given location has useful content for the agent's purpose. In the case of intrinsically derived meta-data, this goal has proved illusive, since conventional signal processing technologies and processes for automatically extracting or deriving intrinsic meta-data for time-based media have proven to be inadequate. For example, when processing videos, the predominant form of time-based media, the application of signal processing analysis typically fails to extract sufficiently high-level semantic descriptions to support an agent's selection decisions.

This inability of low-level signal processing approaches to produce high-level semantic descriptions has created a need for other ways of generating meta-data. Currently, the Motion Picture Experts Group (MPEG) standards committee is proposing an MPEG 7 standard in relation to the creation of locations on video media where meta-data created during production of the video content may reside. By facilitating the creation of such “slots” on the video media for embedding or attaching high-level semantic descriptions derived during the video production process, the MPEG 7 standard improves the retrieval of suitable videos or parts thereof for reuse. However, for archived videos, the problem of meta-data production still remains.

One proposal for creating meta-data relating to archived videos involves the application of speech-to-text conversion technology developed by International Business Machine (IBM) Corporation. Using this speech-to-text conversion process, Virage bypasses low-level signal processing and analysis of videos, relying instead on converting the narrative contained in the audio track in videos to text while preserving the time-code location information of each word. The resulting text file, as a source of extrinsic metadata relating to the video may be searched using conventional text search algorithms. The success of the meta-data creation process using the speech-to-text conversion process is based on the assumption that the contents of the video are adequately described by the narrative contained in the corresponding audio track. The elegance of this proposal is to abandon the creation of intrinsic meta-data from the primary media and instead, rely on extrinsic meta-data derived from the secondary media, the narrative in the audio track, which is fused with the primary media. While not designed as a source of meta-data relating to the video images, the narrative produces better, high-level semantic meta-data, than can be derived directly from the images using signal processing analysis. While not providing a complete description of the video, this approach provides the most accessible description available.

As new genres of fused media content are created, new possibilities for using secondary media attached to the primary media as a resource for extrinsic meta-data relating to the primary media will arise. However, the focus herein is on prior art relating to mechanisms for attaching text and speech annotations as a form of secondary media which may be used as a source of meta-data for a primary, time-based media.

A number of prior art documents teach or disclose technologies that attempt to facilitate extraction or derivation of meta-data from time-based media. In the U.S. Pat. No. 6,006,241, Pumaveja et al discloses the production of synchronization scripts and corresponding annotated multimedia streams for servers and client computers interconnected by computer networks. Such a document teaches a mechanism that attempts to reliably provide a multimedia stream with annotations in a seamless package to client computers efficiently for both network and client computers. This technology facilitates the design of multimedia content and allows the synchronized display of the multimedia stream and annotations over the computer networks. However, once the production of the multimedia content is completed, the annotations used for the production process are deleted from the completed multimedia content that is available for display. That is, the annotations used during the production process do not become part of the finished multimedia product. Hence, no secondary media is available to be used as meta-data.

In the U.S. Pat. No. 5,600,775, King et al discloses a system for annotating full motion video and other indexed data structures. This system allows a distributed multimedia design team to create a complex multimedia document. All the different components of such a document are to be connected in a proper display sequence. Changes to the document during an iterative design process may be disruptive to an indexing system that orders the display of the document components. This system also includes a file look-up mechanism based on an indexed data structure for the annotation and display of annotations of full motion digital video frames. Using this system, the multimedia designers may use overlays as an annotation surface during the production and editing of the multimedia content. The system includes a mechanism for creating annotations without modifying the primary video content and indexed data structures, and in such a system the video and annotations are stored separately. The display of the annotations is done via an overlay so as not to disrupt the video. Individual annotations may be combined into an annotation file. As in the previous prior art document, annotations in this system for the purpose of coordinating distributed design do process not become part of the primary media content. Hence, no secondary media is available to be used as meta-data.

In the International patent application PCT/US99/04506, Liou et al disclose a system for collaborative dynamic video annotation, wherein a user may start or join a video annotation session. The system also re-synchronizes the session with other users, and allows users to record and playback the session at a later date/time. The system allows users to create graphical, text or audio annotations. A disadvantage relating to the system is that the system does not distinguish and separate the meta-data into different types. Moreover, the annotations generated via the system are not used for indexing the video, a process that is known as meta-indexing.

In a paper entitled “A Framework for Asynchronous Collaboration Around Multimedia and its Application to On-Demand Training” (Microsoft Research Technical Report #MSR-TR-99-66, http://research.microsoft.com/scripts/pubs/view.asp?TR_ID=MSR-TR-99-66), Bargeron et al discloses a system for facilitating the use of multimedia for on-demand training, where video clips and text-slides are used to conduct distance training for students. In this system, students may annotate a video lecture with private notes attached to the video. In addition, students may read and post questions attached to the video lecture at a specific location. While this system supports the generation of user annotations attached to specific locations on the video, the system does not provide for the valuation of an annotation. Nor, in a more general sense, does the system have any provisions for refining the history of prior user interaction with the media into an optimised source of meta-data relating to the media. For example, the display of prior user-interaction is limited to the location of the original annotation. There are no provisions for displaying prior viewers' interaction with the video frames or the amount of times that the prior viewers accessed specific annotations. Nor are there any provisions for determining the overall quality of each annotation. Hence the system does not support the optimization of user interaction with the media as a source of meta-data relating to the media.

Other conventional techniques or methodologies, for example those relating to movie reviews, also have inherent limitations when applied to the extraction or derivation of meta-data from time-based media. Although reviews of movie provide similar meta-data description of the movies, such reviews relate to the movies as a whole. As such, these review techniques are too general to provide meta-data relating to the images of the primary media at specific locations within the time-based media's timeline. The value of such meta-data is also limited to a single participant's views.

In general, conventional systems and technologies that generate meta-data from intrinsic sources within the primary media (and the attached sound track) fail to produce high-level, semantic descriptions of the images of the primary media. However, through speech-to-text conversion, using the narrative on the sound track of the video as a source of high-level semantic meta-data relating to the images of the primary media provides an adequate extrinsic source for generating metadata.

From the foregoing problems, there is clearly a need for a system for facilitating collaborative annotation of time-based media, which also includes indexing the time-based media based on annotations created, generating extrinsic meta-data using the annotations, and making available the extrinsic meta-data generated.

### SUMMARY

In accordance with one aspect of the invention, a system for generating meta-data by means of user annotations relating to a time-based media is disclosed, the system comprising means for displaying and controlling the display of a time-based medium; means for receiving and storing input for defining a location in the time-based medium; means for receiving and storing an annotation relating to the context of the location in the time-based medium; and means for performing and storing a valuation relating to the annotation.

In accordance with another aspect of the invention, a method for generating meta-data by means of user annotations relating to a time-based media is disclosed, the method comprising the steps of displaying and controlling a display of a time-based medium; receiving input and storing for defining a location in the time-based medium; receiving and storing an annotation relating to the context of the location in the time-based medium; and performing and storing a valuation relating to the annotation.

### BRIEF DESCRIPTION OF DRAWINGS

Embodiments of the invention are described hereinafter with reference to the drawings, in which:

FIG. 1 is a block diagram relating to a client-server computer architecture upon which a system according to an embodiment of the invention is built using a server and databases;

FIGS. 2a and 2b are screenshots of a Meta-Data Aggregate Display Player provided by the system of FIG. 1 during first and second annotation sessions, in which a video clip provides the subject matter for collaborative annotation whereby annotations undergo pruning and seeding processes;

FIG. 3a is a block diagram relating to an Individual Annotation Process (IAP) in the system of FIG. 1, and FIGS. 3b and 3c are flowcharts relating to the LAP and operations therein, respectively;

FIG. 4a is a block diagram relating to a Collective Annotation Process (CAP) in the system of FIG. 1, and FIG. 4b is a flowchart relating to the CAP;

FIG. 5a is a block diagram relating to a Meta-Data Aggregate Process (MDAP) in the system of FIG. 1, and FIG. 5b is a flowchart relating to the MDAP;

FIG. 6 is a block diagram relating to a process in which annotations are pruned in the system of FIG. 1; and

FIG. 7 is a block diagram relating to a process for generating Meta-Data Aggregate Product in the system of FIG. 1.

### DETAILED DESCRIPTION

A system according to an embodiment of the invention for facilitating collaborative annotation of time-based media is disclosed for addressing the foregoing problems, which includes indexing time-based primary media with annotations, particularly annotations, created by groups of annotators who interact with the primary media for forming fused media. Within this new form of fused media, the annotations may serve as a source of extrinsic high-level semantic meta-data relating to the content of the primary media. During interaction with the primary media, a history of user viewing and annotation production activities as a source of extrinsic meta-data for the primary media, as well as the annotations as a form of secondary media, are displayed. Furthermore, viewer valuations of the annotations that are attached to the primary media may also serve as meta-data relating to both the primary media and secondary media.

The system facilitates the derivation of meta-data as a by-product of a knowledge sharing process in which a group of participants attach textual, audio, or graphical annotations to time-based media. The primary goal of this annotation process is knowledge sharing in a social context for social benefit, for example knowledge sharing between the participants for purposes of education. As such a social process runs over time, a body of annotations and the corresponding attachment locations accumulate. While the participants do not engage in the annotation process for the purpose of meta-data production, the resulting body of annotations with attachment locations may function as a meta-data resource for an agent of a content provider looking for a particular type of time-based media content. Rather than convert the audio track of videos to text or incur cost for the systematic categorization of the videos manually, the system described hereinafter supports a social process designed to optimise the voluntary production of annotations attached to a time-based media for the purpose of generating meta-data.

Although economical to produce, the resulting meta-data from this knowledge sharing process is incomplete in a number of ways. Most importantly, this process is incomplete in the sense that the knowledge sharing process makes no provision for the systematic description of the entire contents of the time-based media. Annotations are only attached at locations in time-based media where viewers or listeners are interested to view or listen. Additionally, a controlled vocabulary is not applied to the contents of the annotations, such as the Dewey Decimal system used by librarians. Hence, the terms expressed in the annotations are not restricted to agreed-upon or accepted definitions, resulting in inconsistent usage amongst annotators. Furthermore, the contents of the annotations are discursive rather than explicitly categorical. Potential key words are used thematically in narratives, resulting in differing shades of meaning depending on contexts of use of these words in annotations. The net result is a series of interpretive narratives about the time-based media rather that a checklist of attributes contained within the time-based media.

Due to the nature of annotation processes, incomplete meta-data is therefore produced since the goals of knowledge sharing are fundamentally different from the form of categorization required to systematically inventory the content in time-based media, for example the images and audio contained in a video. The two activities are basically different in kind, so there is little opportunity to directly improve the systematicness of the annotation process without adversely affecting the process of free-form knowledge sharing. However, there are a number of ways to directly improve the annotation process, which as a side effect may benefit the use of those annotations as meta-data. Like the use of the audio track by Virage in which any coherent high-level semantic description becomes a form of meta-data, it may be possible to improve the thematic coherence of the free-form annotation process resulting from knowledge sharing. The system further achieves this by leveraging on a few fundamental properties of unconstrained annotation processes relating to time-based media such as video discussed hereinafter.

Textual annotations attached to video are examples of media convergence. In this case, an agent for a video content provider may view the video, and through the corresponding links based on time-codes, also view the annotations. Since the attachments of this fused media are bi-directional, viewers may then use either primary or secondary media to access the corresponding location in the other media. Attached annotations may occur anywhere along the time-code of the primary time-based media. Annotations are created as viewers react to something that the viewers have just observed in the video. Annotations are also created as the viewers react to previously written annotations. While the primary media may provide the initial impetus for annotation, over time the issues discussed in the annotations may also come to have value. Because the two types of media are fused through time-code links, viewing one type of media may serve as meta-data for the other.

As more people react to a video by attaching annotations, the total volume of annotations eventually becomes large. For example, if 100 people watched a video and each wrote 10 annotations, these 100 people then produce 1000 annotations. Because each person has a unique way of viewing the world, the interpretive contents of the annotations are unconstrained. That is, N people may watch a segment of video and interpret the segment in N ways. While there may be overlap between interpretations, in the sense that the interpretations refer to the same event, the specifics of the interpretations may be radically different, or even antithetical to each other. As a result of the large volume of annotations and the lack of a uniform framework for formulating the annotations, the contents of annotations are typically fragmented. Fragmented annotations are problematic as meta-data, since the degree of ambiguity across the annotations is potentially quite large.

However, within the total set of annotations, small subsets of the annotations are dialogic in the sense that a conversation ensues between two or more annotators. At these locations, the annotations eventually evolve thematically as the annotators progressively clarify the meaning of what the annotators are saying through successive turns in the conversation. Whether the annotators subsequently agree or disagree on a single interpretation is not important. What matters is that during the asynchronous discourse process, the annotators use a variety of communication conventions for establishing mutual understanding. The net result is a more coherent expression of ideas across annotators than is achievable with each annotation performed in isolation. As coherence amongst annotations increases, the degree of ambiguity reduces, enabling an agent to have more confidence in the descriptions of what the agent expects to find at that location in the primary media.

The accumulated annotations voluntarily attached to the primary time-based media may be of varying quality. Inevitably, some interpretations are more informative than others. These more informative annotations tend to draw subsequent responses, becoming the “roots” for local dialogues that are more thematic in nature than the surrounding “isolated” annotations.

Given the voluntary authorship, uncontrolled and fragmented interpretations, and the resulting large interpretive spaces of the annotation process during knowledge sharing over time, it is proposed herein that the primary means to achieve a semblance of coherence across interpretations is to focus on developing emerging themes through dialogue across annotators. A method for achieving this is implemented in the system and consists of the component processes or steps described hereinafter.

As knowledge sharing participants watch a video, the participants begin to populate the secondary media with the participants' annotations relating to the primary media. Since the annotation space may become large over time, the participants are encouraged to provide valuations by rating the annotations the participants read as a form of navigational meta-data relating to the secondary media. As participants selectively read annotations authored by other participants, points of contention or interest eventually arise, serving as root nodes in the secondary media for the growth of threaded discussions within the secondary media. In order to carry on these threaded discussions, the participating authors have to maintain greater coherence in the content across annotations. Here the problems of fragmented annotations and lack of a controlled vocabulary are reduced by the constraint of mutual intelligibility required for the conversation to proceed. As a result, the high-level semantic content produced by this dialogic process eventually becomes more suitable for use as meta-data relating to the images within the primary media. To the extent that dialogues may be encouraged across larger areas of the primary media, the resulting annotations produce more useable meta-data than bodies of annotations that fail to coalesce into dialogues. Processes that stimulate discussion activities increase local coherence across annotations, which enable the system to provide agents with better support for viewing decisions about segments in the primary media.

With peer rating of annotations within the secondary media, it is then possible to run a annotation cycle in which a finite number of annotators may generate annotations for a predefined period of time, which is known hereinafter as a annotation cycle. Once an annotation cycle is completed, no more annotations may be added. Using the peer ratings to identify a threshold for superior annotations, the database of annotations may be eliminated or pruned of all annotations that fall below that threshold. The remaining annotations and the original primary media are then presented to a new annotation cycle, such a process hereinafter known as seeding, consisting of a finite number of annotators over another predefined period of time. Due to the generative property of both the primary media and the remaining annotations, a subset of the annotation within the new annotation cycle is in response to, and a further elaboration of, the themes that are preserved from the previous annotation cycle. In this manner, the growth of local thematic networks is encouraged within a progressively expanding annotation space. The process repeats iteratively through a finite number of annotation cycles until the annotation space is populated with more tightly intertwined annotation of superior quality as operationally defined through peer rating.

The resulting fused media produced by these processes improves on the ability of the accumulated annotations to act as a source of meta-data in two ways. Firstly, by responding to the preserved annotations during subsequent annotation cycles, annotators produce a more tightly coupled body of annotation organized around emerging themes. Secondly, because the annotations are more thematically related, an agent may expect more consistent usage of terms among the annotations. This follows from the fact that participants must maintain an acceptable level of coherence across the conversations in order for the dialogues to be intelligible. As a result of these two factors, evolving bodies of annotations produced by this process of multi-generational pruning and seeding have the desirable property of being better self-documented than annotations produced by an unconstrained annotation process. When these annotations are used as meta-data, through keyword searches and text mining operations, there should be less discrepancy between what the agent expects to find and the actual results of the query.

The fused media produced by this process is unique. A viewer may access the linked contents through either media. Organized into evolving themes based on mandatory peer rating, the remaining content is useful as a form of information and as meta-data through time-code linkages. Where pure meta-data subsists outside the primary media for serving a descriptive purpose, the fused media approach elevates the meta-data which are annotations to a position of equal prominence with the primary media. That is, an agent whose initial intention is to find valuable primary media may wish to acquire the annotations associated with those primary media as well. The resulting fusion between the two linked media is greater than the sum of its parts, and the system provides the computer support for the processes that produce this product.

In the system, meta-data that is processed preferably relates to the context for which the time-based media is created or brought forward for discussion. The system through several processes facilitates the rating of the value or richness of meta-data associated with the time-based media, and generally how the time-based media fairs in the context decided. For example, the system allows a user to take a video clip of a tennis serve, and define the context as ‘quality of serve’ so that the ensuing processes generate meta-data based on input from other users who annotation on the pros and cons of the tennis serve.

An advantage afforded by the system is that the system allows for generation of rating data from meta-data for indexing time-based media, as opposed to the superficial speech-to-text indexing of keywords afforded by conventional systems. In other words, the system creates the context for which meta-data may be valuated and converted into rating-data used for indexing the time-based media. The system also performs an iterative process of evaluating the worth of the meta-data through a rating mechanism and retaining meta-data rated to be of high worth and discarding what is not. This method of rating the meta-data is differentiated from conventional systems that rate the time-based media.

The system according to an embodiment of the invention therefore goes beyond any conventional computer-based system for annotating a time-based media.

System Architecture

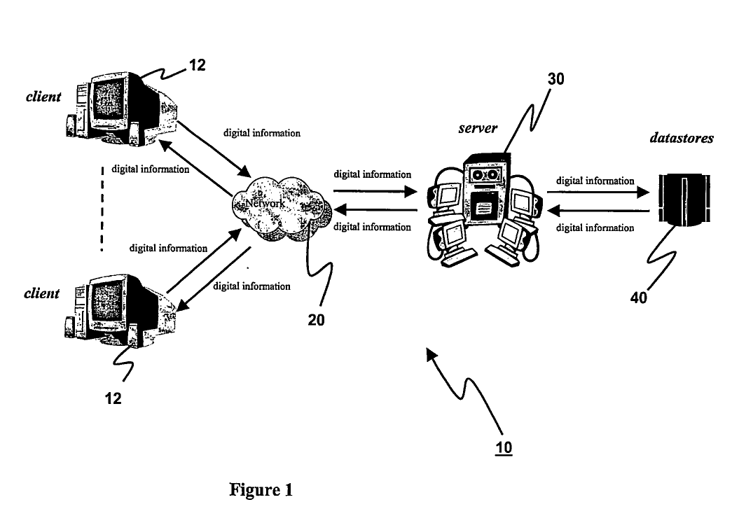

With reference to FIG. 1, a client-server computer architecture upon which the system according to a preferred embodiment of the invention is preferably built is described hereinafter. The client-server computer architecture 10 enables clients 12 to connect through a network 20, which is either a local area network (LAN) or wide area network (WAN) such as the Internet, to a server 30. Digital information is exchanged, such as queries, and static and dynamic data, between the clients 12 and the server 30. The server 30 provides the system logic and workflow in the system and interacts with various databases 40 for submitting, modifying and retrieving data. The databases 40 provide storage in the system.

Operations in the system are divided into three main processes that together form a mechanism for generating Meta-Data Aggregate Product, which consists of primary media and meta-data relating thereto. The processes are Annotation Cycle Process, a Meta-Data Aggregate Process, and an Additional Meta-Data Generation Process.

The Annotation Cycle Process is a process for generating and updating annotations which are present or for storage in the databases 40, which is done by annotating processes such as the generation of annotations and survey questions. The Meta-Data Aggregate Process is a process for extracting high quality meta-data consisting of annotations and other information such as ratings of annotations from the databases 40. Annotations generated in the Annotation Cycle Process cycles are further processed in the Meta-Data Aggregate Process and forms the basis for perpetuating or seeding subsequent annotation cycles. The Additional Meta-Data Generation Process is a process for generating additional meta-data relating to the time-based media such as through a prologue and epilogue. The Annotation Cycle Process and Meta-Data Aggregate Process provide input to this process.

Time-based media may be annotated with text, graphics, and audio without any modification to the original time-based media. The time-based media and annotations are preferably stored separately.

Time-codes present in the time-based media are preferably used in an indexing feature in the system for allowing users to attach meta-data to specific locations of the time-based media stream for indexing the time-based media. A typical example of a time-based media is video in which meta-data is attached to specific locations in the video strewn by means of time-codes in the video. In the system, time-codes are preferably added to annotations as indicators corresponding to locations in the video to which the annotations pertain. The time-codes may be represented as seconds/minutes/hours or any other unit of time or frame counts as frame numbers.

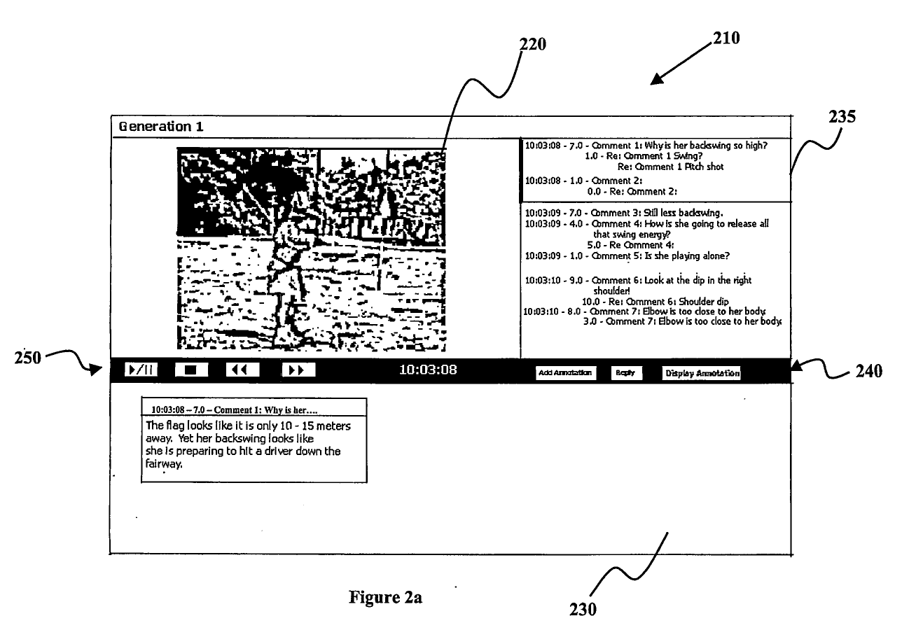

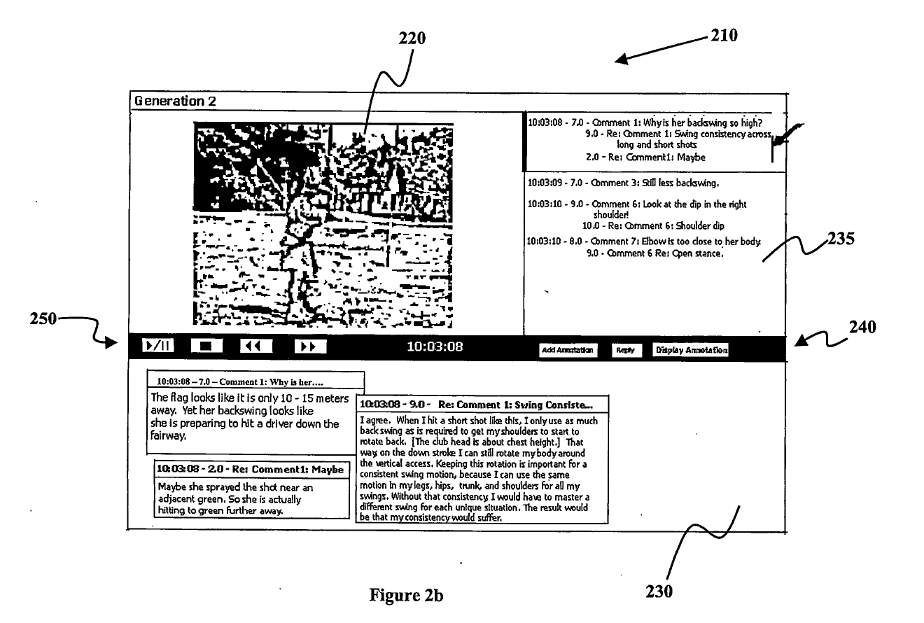

With reference to FIGS. 2a and 2b, a Meta-Data Aggregate Display Player used in the system for preferably providing the users with a user-interface for interacting through the clients 12 with the system and allowing the users to access the server 30 and databases 40 is described in greater detail. The Meta-Data Aggregate Display Player 210 consists of a Media Display Window 220 for displaying the time-based media, which in this example is a video clip of a golfer making a swing, as well as an Annotation Display Window 230 for displaying the annotations, and an Index Display Window 235 for displaying the indexing feature. A set of Annotation Control Buttons 240 is used to control the functionality relating to the annotations, rating data, and indexing feature, while a set of Media Control Buttons 250 controls the time-based media.

The features afforded by the Meta-Data Aggregate Display Player 210 may include allowing the users to make copies of the time-based media and rating data. The features may also include controlling the total number of users who may access the system or number of users who may simultaneously access the system. The features may further include controlling the number of views, length of time the Meta-Data Aggregate Product, described hereinafter, is made available to the users, and type of tools such as search and display tools.

In order to make use of the Meta-Data Aggregate Product which is licenced or bought by the users, the Meta-Data Aggregate Display Player 210 is required. The Meta-Data Aggregate Display Player 210 provides ways to view the time-based media, annotations, prologues, epilogues, and meta-data used to index the time-based media. The Meta-Data Aggregate Display Player 210 may be provided as a standalone application, part of a Web browser, an applet, a Webpage or the like display mechanism.

A scenario in which the users provide annotations and rate the annotations for forming rating data in relation the video clip of the golfer is described with reference to FIGS. 2a and 2b. In FIG. 2a, the Media Display Window 220 is showing the video clip in which the golfer's swing is of interest to users of the system. The video clip is first selected and stored in the system by an author who wishes to generate interest and solicit annotations from users of the system in relation to the golfer's swing. The system then makes available the video clip to users of the system, who may then view the video clip using the Meta-Data Aggregate Display Player 210. The users may control the viewing of the video clip using the Media Control Buttons 250, which preferably includes buttons for accessing playback, pause, stop, rewind and fast forward functions. When any users wish to add annotations or reply or add to annotations from other users in relation to various parts of the video stream, the users may do so using the Annotation Control Buttons 240, which preferably includes buttons for add, reply to, or display annotation functions. These annotations are then stored in the system and displayed in the Annotation Display Window 230 when selected. The Index Display Window 235 displays a list consisting of time-codes added to the annotations, the ratings of the annotations, and a short title of the annotations for providing the indexing feature for locating the corresponding location in the time-based media. The selected annotation is shown in the Annotation Display Window 230 by the selection of the annotation from the list and choosing to view the annotation using the view annotation button

The users of the system who are interested in the various parts of the video stream to which the annotations pertain provide the ratings of these annotations. These users may also add annotations or reply to other annotations, which may thereafter solicit ratings of such annotations or replies from other users. This sequence of adding annotations and soliciting ratings for the annotations in a prescribed period forms a annotation cycle, and the annotations with the best ratings or those that meet prescribed criteria are stored and displayed in subsequent annotation cycles for perpetuating the addition or reply of annotations and rating thereof. In FIG. 2b, the annotation time-coded at 10:03:08 with a short title “Why is her backswing so high?” is retained in a second annotation cycle for fuelling further annotations or replies thereto after being given a rating of 7.0 in a first annotation cycle as shown in FIG. 2a. Other annotations with lower ratings or that do not meet the prescribed criteria are not perpetuated in the second annotation cycle.

The prescribed period and criteria may be set by the author or other users of the system. The author may also provide a prologue providing a description of the video clip for setting the context to which the annotations and replies thereto pertain. At the end of each annotation cycle, an epilogue may be also provided either by any one or any group of users with an interest in the video clip. The prologue and epilogue are in effect another form of meta-data which may be used for indexing the time-based media, but at a superficial level.

The ratings provided by users of the system for each annotation may be averaged and reflected as a rating indicative of each annotation in the system. Alternatively, the highest or lowest rating for each annotation may also be reflected as a rating indicative of the respective annotation.

Annotation Cycle Process

The Annotation Cycle Process is described in greater detail hereinafter, which consists of three different processes, namely an Individual Annotation Process (IAP), an Individual Annotation Session (IAS), and a Collective Annotation Process (CAP).

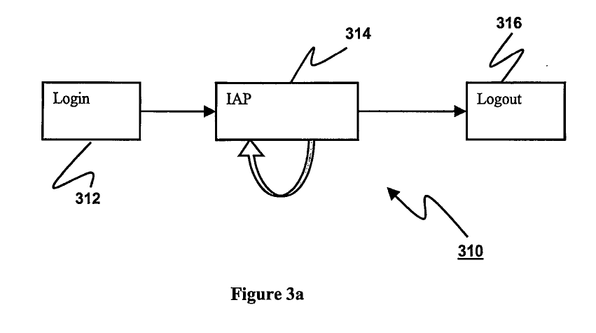

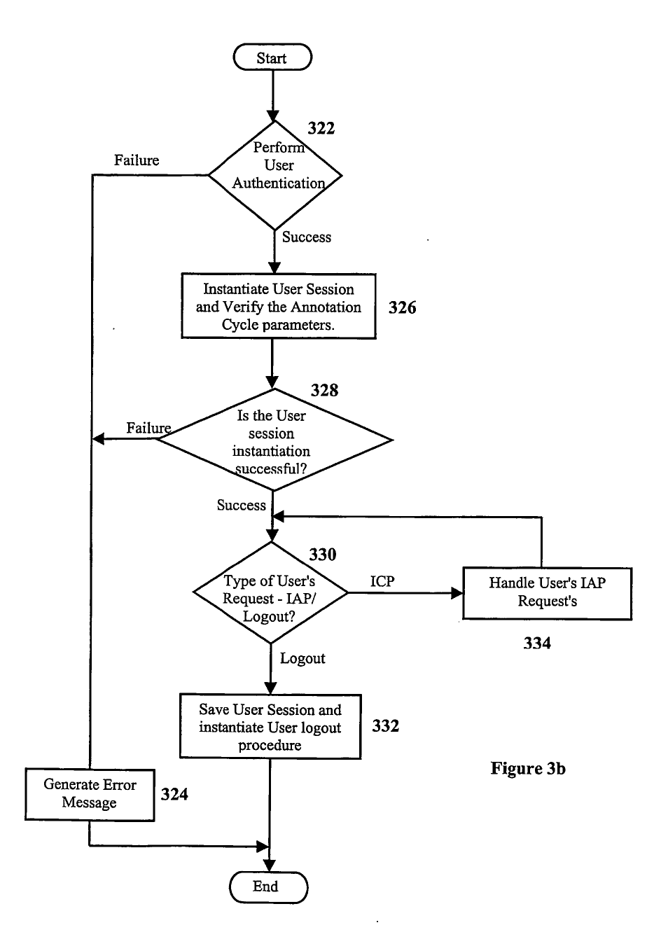

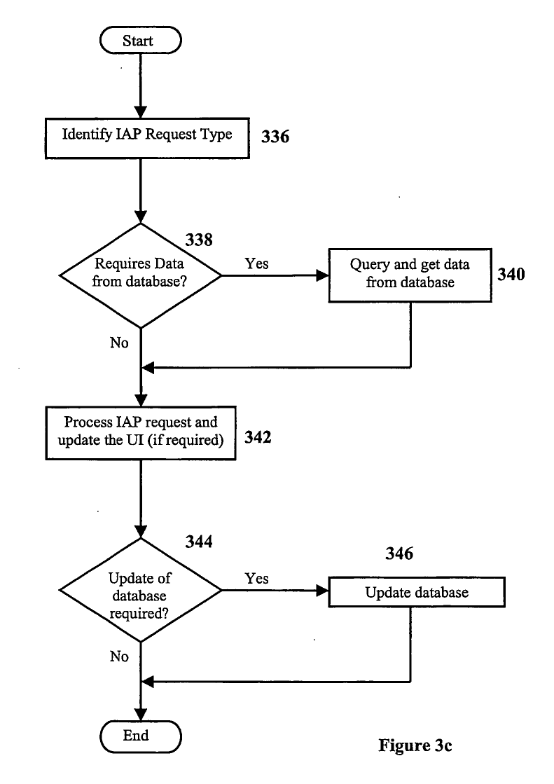

With reference to FIG. 3a, which is a block diagram relating to the Individual Annotation Process (IAP), the IAP 310 is described in greater detail hereinafter. The IAP 310 is a set of actions taken after the user performs a user login 312 to begin a user session, through an iteration of the atomic operations and performing one to any number of these atomic operations, and before the user performs a user logout 316 to end the user session. All IAPs 310 in a single user session constitute an Individual Annotation Session (IAS). The user session defines a period between a successful user login to a successful user logout. The user logout may be forced by the system if the user session remains inactive for a period longer than the defined inactivity period.

A set of atomic operations forms the lowest level of input to the IAP 310 provided by users of the system. The users may create new annotation threads and thereby as authors start a topic that generates replies on a certain segment or issue corresponding to a location of the time-based media. The users may also rate existing annotations and thereby create the basis for one way to screen and aggregate annotations, such as by perceived worth. The users may also create new survey questions such as multiple-choice questions, percentage questions allocating percentages to the different choices, and rating questions. The users may also respond to existing annotations and thereby add value to the current annotation thread through the discussion. Through selecting annotations the users may read what has been discussed so far. After having viewed a survey question, the users may also respond to the survey question much like a normal annotation, in order to facilitate a discussion on issues raised by the survey question. Like the rating of annotations, survey questions may also be rated. The users may view the survey questions which then if applicable trigger the rating.

With reference to FIGS. 3b and 3c, which are flowcharts relating to the IAP 310 and the atomic operations therein, the process flow of the IAP 310 and the atomic operations are described in greater details. In a step 322 shown in FIG. 3b, the user performs user login which if fails, the system generates an error message in a step 324 and the IAP 310 ends thereafter. If the login is successful, the system in a step 326 instantiates a user session and verifies annotation cycle parameters such as username and password. The system then in a step 328 checks if the instantiation is successful, which if fails, the system also generates an error message in the step 324 and ends the IAP 310 thereafter. If the instantiation is successful, the system in a step 330 checks the nature of the user's request, which if is a logout request, the system proceeds to a next step 332 to save the user session and instantiate the logout procedures. If the user's request is to perform an atomic operation, the system proceeds to a step 334 in which the requested atomic operation is performed.

Within the step 334, a request to perform an atomic operation is fulfilled by a series of steps described hereinafter with reference to FIG. 3c. In a step 336, the atomic operation is identified from the user request and the system checks if the atomic operation requires data from the databases 40 in a step 338. If the atomic operation requires data from the databases 40, the server 30 queries the databases 40 and retrieves the relevant data in a step 340. Thereafter, or if the atomic operations does not require data from the databases 40, the system proceeds to a next step 342 and processes the atomic operation and updates the Meta-Data Aggregate Display Player 210. After processing the atomic operation, the system checks in a step 344 if the databases 40 are to be updated, and does so in a step 346. Thereafter, or if the databases 40 need not be updated, the system returns to the step 330 as shown in FIG. 3b.

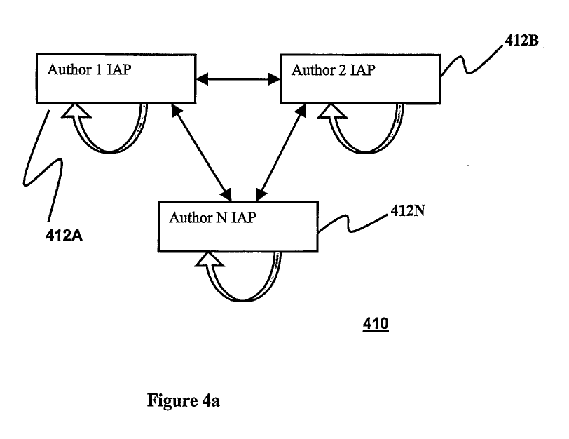

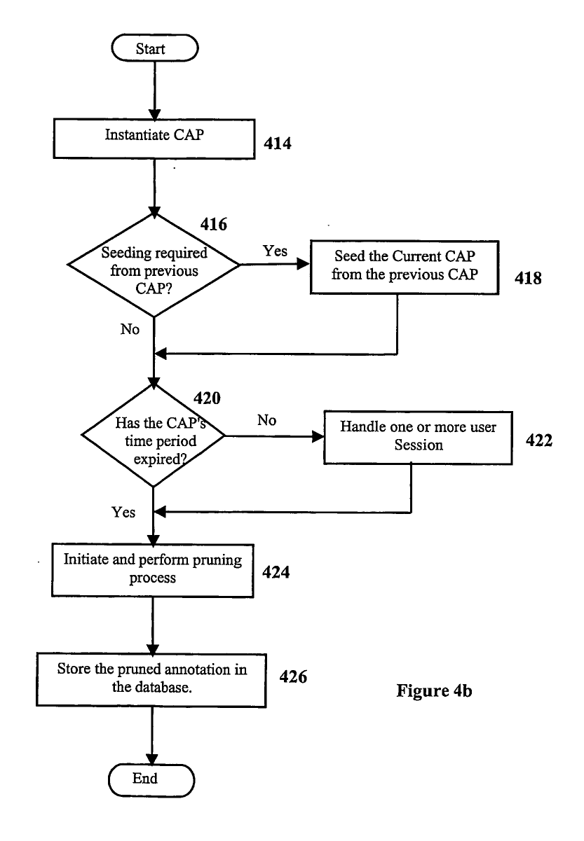

With reference to FIG. 4a, the Collective Annotation Process (CAP) 410 is described in greater detail hereinafter. A number of IAPs 310 constitute a CAP 410 for defining an annotation cycle, and the CAP 410 may run for a finite period or indefinitely for a particular time-based media. The CAP 410 is a concurrent repetitive process, and is formed by iteratively performing IAPs 310 relating to each user 412. In the CAP 410, different users 412 go through different iteratively performed IAPs 310 which are connected only by the time-based media. For example, in the CAP 410 user 1 (412A) performs an associated IAP 310 several times, adding value and content to the process by creating annotations and survey questions. Meanwhile, user 2 (412B) through to user N (412N) in the CAP 410 also do likewise, responding to the annotations provided by the other users, as these users also go through the respective iteratively performed IAPs 310. With reference to FIG. 4b, which is a flowchart relating to the CAP 410, the process flow of the CAP 410 is described in greater details. In a step 414, the CAP 410 is instantiated and in a next step 416 the system checks if annotations are being processed during an annotation cycle are selected from the previous CAP 410 for perpetuating in the current CAP 410. If the result is yes, these annotations are used to seed the current CAP 410 in a step 418, and the system thereafter, or if the result is no in the step 416, proceeds to a next step 420 in which the system checks if the annotation cycle period relating to the current CAP 410 is expired. If the annotation cycle period is not expired, the system proceeds to handle one or more user sessions or IAPs 310 where annotations are added or rated, and thereafter, or if the annotation cycle period is expired, in a next step 424 the system initiates and performs a pruning process. In the pruning process, to be described in greater detail hereinafter, annotations including the seeded annotations, are pruned based on the rating or other prescribed criteria, and the pruned annotations are stored in the databases 40 in a step 426.

Meta-Data Aggregate Process

The Meta-Data Aggregate Process (MDAP) is a process for extracting high quality meta-data consisting of annotations and other information such as ratings of annotations from the databases 40. High quality meta-data is defined as meta-data having a high value in the context as defined in the beginning of the CAP 410.

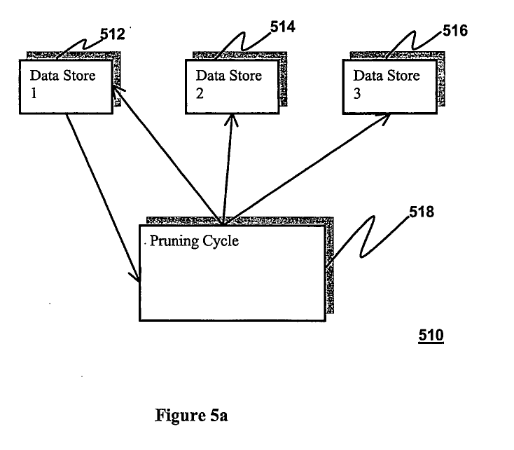

With reference to FIG. 5a, the MDAP 510 is described in greater detail. The duration of each MDAP 510 spans a number of CAPs 410 defined either by the author or the system. The MDAP 510 involves the databases 40, which includes data store 1 (512), data store 2 (514), data store 3 (516), and a pruning cycle 518. Whenever the users provide annotations in a CAP 410, such annotations are deposited in the data store 1 (512) as data. During the MDAP 510, all annotations from the current annotation cycle or CAP 410 and selected annotations from the previous annotation cycle or CAP 410 is taken from data store 1 (512) and passed through the pruning cycle 518 where data depending on the prescribed criteria are deposited either in the data store 1 (512), data store 2 (514) or data store 3 (516). In a preferred implementation a failed piece of data is deposited in the data store 3 (516) where the failed data is stored as part of a complete archive of annotations. Data that passes the prescribed criteria is deposited in the data store 1 (512) as a working database for the MDAP 510 and as seed material for the next annotation cycle or CAP 410, as well as in data store 2 (514) for archiving purposes.

With reference to FIG. 5b, which is a flowchart relating to the MDAP 510, the process flow of the MDAP 510 is described in greater detail. In a step 520, the MDAP 510 is instantiated with the prescribed number of CAPs 510 that are to occur during the MDAP 510 and in a next step 522 the databases 40 are initialized. In a step 524 the system checks if the number of CAPs 410 to occur is satisfied, and if not satisfied, the system initializes a new CAP in a step 526 and thereafter returns to the step 524. If the condition in step 524 is satisfied, the system proceeds to a next step 568 to archive the data relating to the annotations in the databases 40.

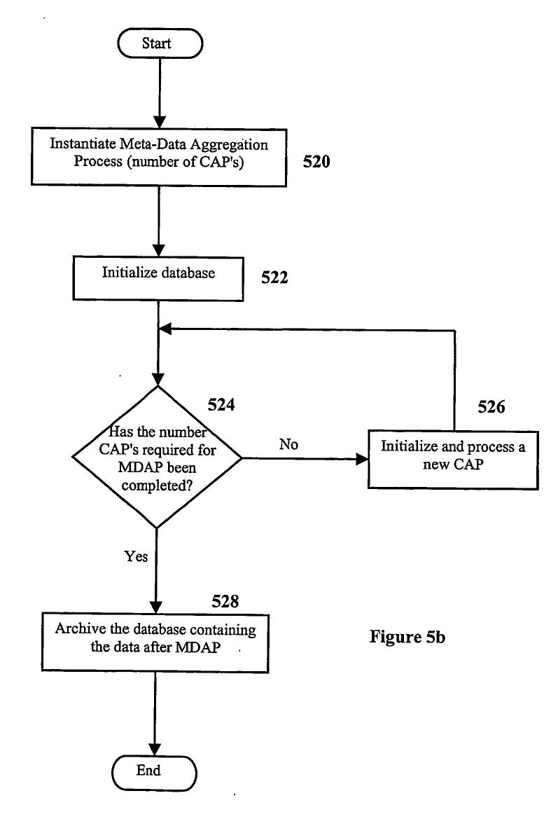

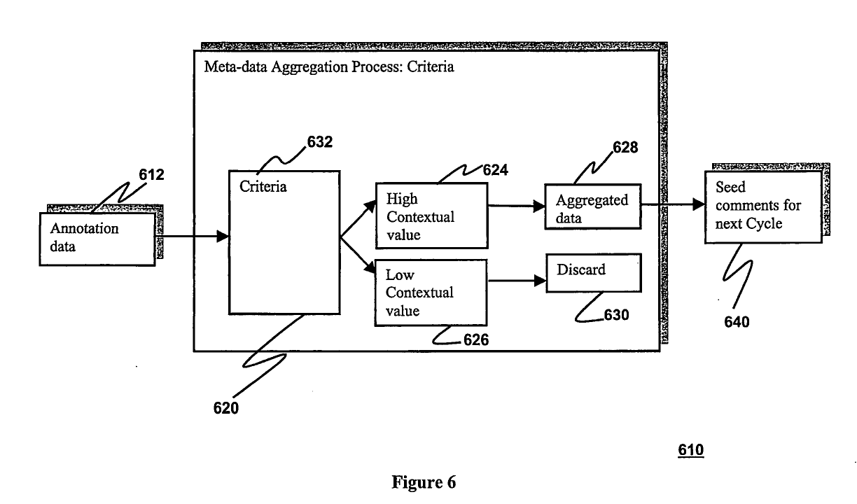

With reference to FIG. 6, the pruning cycle 518 is described in greater detail. When the pruning cycle 518 is triggered at the end of each CAP 410 in the step 424 as shown in FIG. 4b, the pruning of annotations starts with the annotation data 612 being extracted from data store 1 (512) and passed through the MDAP 510. The data is matched with the prescribed criteria in a step 632 and if the data fails the prescribed criteria due to being of lower meta-data value in a step 626, the data is deselected or discarded in a step 630 in the MDAP 510 and archived in the data store 3 (516) for later usage, if necessary. Data that is of higher meta-data value based on the prescribed criteria is passed in a step 624 with all passed data forming a set of aggregated data 628 for forming seed annotation in a step 640 for the next annotation cycle or CAP 410. The prescribed criteria for pruning may be set differently for each cycle. Each run of the pruning cycle 518 creates annotations used to seed the next CAP 410, or if the CAP 410 is the last CAP 410 in the MDAP 510, the pruning cycle 518 creates a last set of aggregated data in a step 628 used in forming the Meta-Data Aggregate Product.

A filter is used to describe the behavior of the pruning cycle 518, in which the prescribed criteria for aggregating the annotations are defined as the filter parameters. Annotations are then matched with these filter parameters, which include average ratings for the annotations; cumulative average rating for annotators; annotations by top annotator; and annotations not deemed of low worth, but are off-context or offensive in any manner.

Depending on the context set for the time-based media and desired outcome, various combinations of the prescribed criteria may require the need for additional fields in the annotations. For instance, in order to implement the filter parameter relating to the average ratings for the annotations, a rating mechanism must be implemented for generating ratings for the annotations and attaching these ratings to the annotations. The rating mechanism would enable the users to rate each other's annotation and then average out the rating for each annotation.

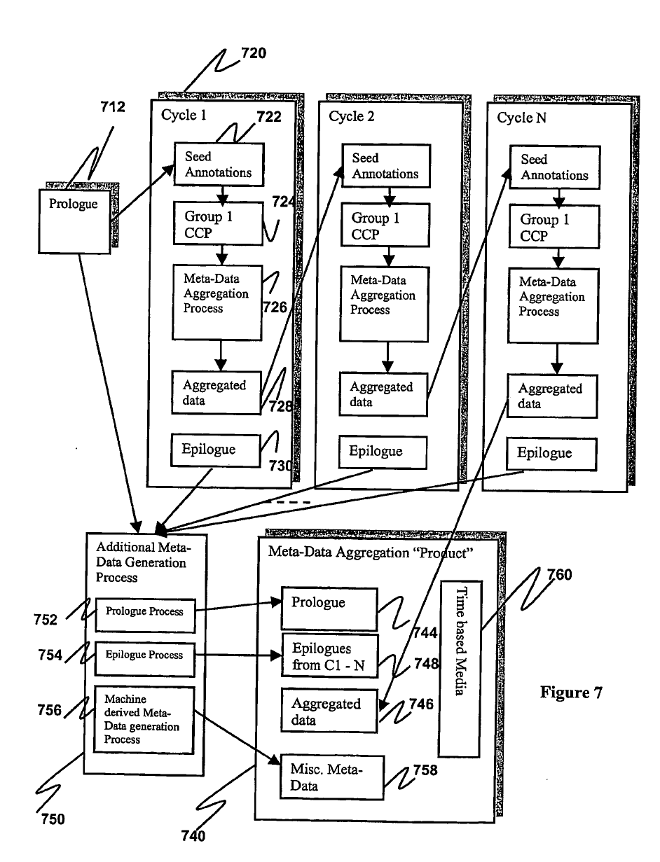

With reference to FIG. 7, an overview of a process for generating Meta-Data Aggregate Product 740 is described hereinafter. An iterative process cycle 720 starts with the creation of a prologue in a step 712 to the time-based media, thereby setting a context. The prologue and seed annotations, which are optional for first iterative process cycle 720, are used to start up a first group of CAPs 410 in a step 724, of which the final output is processed in a MDAP 510 in a step 726. The annotations resulting from the MDAP 510 are aggregated into aggregated annotations in a step 728 and are provided as seed annotations for the next iterative cycle process 720. An epilogue is also created in a step 730, for example for summarising the outcome of the iterative process cycle 720, or for providing information relating other useful meta-data created in the iterative process cycle 720 but did not pass the pruning cycle 518.

The Additional Meta-Data Generation Process 750 is a process of generating additional meta-data for the time-based media as a whole using the prologue and epilogues associated with the time-based media. The time-based media is associated with one prologue, which is written by the author who adds the time-based media to the server 30 at the beginning in the step 712. A Prologue Process 752 uses the prologue written by the author in the step 712 to generate a final prologue 744 for the Meta-Data Aggregate Product 740. An Epilogue Process 754 generates the epilogues for the time-based media. The Epilogue Process 754 gathers a summary (epilogue) from the users of a CAP 410 relating to a particular time-based media. The Epilogue Process 754 may run for selected or all participants in the CAP 410.

The Epilogue Process 754 may run in offline and online modes. In relation to the offline mode, when a CAP 410 ends, a request is sent electronically, for example via email, to the participants, requesting for an epilogue. A participant is not in an active user session for the offline mode, and therefore processes the request and returns the epilogue offline. In relation to the online mode, the Epilogue Process 754 starts before the CAP 410 ends and sends the request to the participants who are in active session. The participants then add the epilogue.

The AMDGP uses both the prologue and epilogues to generate meta-data for the time-based media. The prologue or epilogue may be used in entirety, in part, or parsed for additional criteria, either manually or automatically. The criteria for parsing the prologue or epilogue may be similar to those used in the MDAP 510.

A Machine Derived Meta-Data Generation process 756 is a process through which automated tools such as third part processes or methodologies are used to generate meta-data based on any part of the Meta-Data Aggregate Product 740. The tool may be based on keyword search, context abstraction, sound-to-text indexing, image content definition, and the like technologies.

After N iterations of the iterative process cycles 720, the Meta-Data Aggregate Product 740 is compiled based on the final prologue 744, aggregated annotations 746 aggregated in the step 728 in the last or Nth iterative process cycle, the epilogues consolidated in the epilogue process 754, miscellaneous meta-data 758 created in the Machine Derived Meta-Data Generation Process 756, and the time based media 760 itself. The Meta-Data Aggregate Product 740 is then made available for display or provided as input to other related systems for further processing.

In the foregoing manner, a system relating to the production of high-level semantic meta-data for time-based media as a by-product of an iterative collaborative annotation system for distributed knowledge sharing in relation to the time-based media is described for addressing the foregoing problems associated with conventional systems and technologies. Although only a number of embodiments of the invention are disclosed, it will be apparent to one skilled in the art in view of this disclosure that numerous changes and/or modification can be made without departing from the scope and spirit of the invention. For example, minor modifications may be made to the system to facilitate collaborative annotation of context-based media, which also includes time-based media, such as drawings or books stored and displayable in electronic form. For drawings, coordinates of locations in drawings the context of which is to form subject matter for discussion and annotation may be used to index the drawings in lieu of time-codes used for indexing time-based media such as video, and therefore the system may be modified accordingly to process location coordinates.

1. A system for generating meta-data by means of user annotations relating to a time-based media, comprising:
means for displaying and controlling the display of a time-based medium;
means for receiving and storing input for defining a location in the time-based medium;
means for receiving and storing an annotation relating to the context of the location in the time-based medium; and
means for performing and storing a valuation relating to the annotation.

2. The system as in claim 1, wherein the valuation relating to the annotation is a rating of the annotation.

3. The system as in claim 2, wherein the means for storing the annotation includes means for linking the stored annotation to the time-based medium.

4. The system as in claim 2, further comprising means for facilitating collaborative annotation by a plurality of users in a first group.

5. The system as in claim 4, wherein the means for facilitating collaborative annotation includes means for receiving and storing annotations from a plurality of users in the first group relating to the contexts of a plurality of locations.

6. The system as in claim 5, wherein the means for facilitating collaborative annotation further includes means for receiving ratings relating to the annotations from a plurality of users in the group.

7. The system as in claim 6, wherein the means for facilitating collaborative annotation further includes means for aggregating the annotations.

8. The system as in claim 7, wherein the means for facilitating collaborative annotation further includes means for selecting an annotation from the annotations based on the rating relating to the selected annotation.

9. The system as in claim 8, wherein the means for selecting the annotation includes means for selecting the annotation based on a rating threshold.

10. The system as in claim 8, wherein the means for facilitating collaborative annotation further includes means for receiving annotations from a plurality of users in a second group relating to the contexts of a plurality of locations in the time-based medium and the selected annotation relating to a first group.

11. The system as in claim 10, wherein the means for facilitating collaborative annotation further includes means for receiving ratings from a plurality of users in the second group relating to the annotations relating to the second group and the selected annotation relating to the first group.

12. The system as in claim 11, wherein the means for facilitating collaborative annotation further includes means for aggregating the annotations relating to the second group and the selected annotation relating to the first group.

13. The system as in claim 12, wherein the means for facilitating collaborative annotation further includes means for selecting an annotation from the annotations relating to the second group and the selected annotation relating to the first group based on the rating relating to the selected annotation.

14. The system as in claim 13, wherein the means for facilitating collaborative annotation further includes means for consolidating the annotations relating to the second group and the selected annotation relating to the first group when annotations and ratings are provided by a predetermined number of groups.

15. The system as in claim 14, further comprising means for indexing the plurality of locations in the time-based medium with corresponding consolidated annotations.

16. The system as in claim 14, further comprising means for linking the plurality of locations in the time-based medium with corresponding aggregated annotations.

17. The system as in claim 16, further comprising means for storing the consolidated and aggregated annotations.

18. The system as in claim 17, further comprising means for bundling the time-based media, the consolidated annotations, and the links between the time-based medium and the corresponding aggregated annotations.

19. The system as in claim 18, wherein the means for bundling further bundles machine derived meta-data with the time-based media, the consolidated annotations, and the links between the time-based medium and the corresponding aggregated annotations.

20. The system as in claim 18, further comprising means for displaying the consolidated annotations.

21. The system as in claim 18, further comprising means for providing as output the consolidated annotations.

22. A method for generating meta-data by means of user annotations relating to a time-based media, comprising the steps of:
displaying and controlling the display of a time-based medium;
receiving and storing input for defining a location in the time-based medium;
receiving and storing an annotation relating to the context of the location in the time-based medium; and
performing and storing a valuation relating to the annotation.

23. The method as in claim 22, wherein the step of performing and storing the valuation includes the step of performing and storing a rating of the annotation.

24. The method as in claim 23, wherein the step of storing the annotation includes the step of linking the stored annotation to the time-based medium.

25. The method as in claim 22, further comprising the step of facilitating collaborative annotation by a plurality of users in a first group.

26. The method as in claim 25, wherein the step of facilitating collaborative annotation includes the step of receiving annotations from a plurality of users in the group relating to the contexts of a plurality of locations.

27. The method as in claim 26, wherein the step of facilitating collaborative annotation further includes the step of receiving ratings relating to the annotations from a plurality of users in the first group.

28. The method as in claim 27, wherein the step of facilitating collaborative annotation further includes the step of aggregating the annotations.

29. The method as in claim 28, wherein the step of facilitating collaborative annotation further includes the step of selecting an annotation from the annotations based on the rating relating to the selected annotation.

30. The method as in claim 29, wherein the step of selecting the annotation includes the step of selecting the annotation based on a rating threshold.

31. The method as in claim 29, wherein the step of facilitating collaborative annotation further includes the step of receiving annotations from a plurality of users in a second group relating to the contexts of a plurality of locations in the time-based medium and the selected annotation relating to a first group.

32. The method as in claim 31, wherein the step of facilitating collaborative annotation further includes the step of receiving ratings from a plurality of users in the second group relating to the annotations relating to the second group and the selected annotation relating to the first group.

33. The method as in claim 32, wherein the step of facilitating collaborative annotation further includes the step of aggregating the annotations relating to the second group and the selected annotation relating to the first group.

34. The method as in claim 33, wherein the step of facilitating collaborative annotation further includes the step of selecting an annotation from the annotations relating to the second group and the selected annotation relating to the first group based on the rating relating to the selected annotation.

35. The method as in claim 34, wherein the step of facilitating collaborative annotation further includes the step of consolidating the annotations relating to the second group and the selected annotation relating to the first group when annotations and ratings are provided by a predetermined number of groups.

36. The method as in claim 35, further comprising the step of indexing the plurality of locations in the time-based medium with corresponding consolidated annotations.

37. The method as in claim 35, further comprising the step of linking the plurality of locations in the time-based medium with corresponding aggregated annotations.

38. The method as in claim 37, further comprising the step of storing the consolidated and aggregated annotations.

39. The method as in claim 38, further comprising the step of bundling the time-based media, the consolidated annotations, and the links between the time-based medium and the corresponding aggregated annotations.

40. The method as in claim 39, wherein the step of bundling further includes bundling machine derived meta-data with the time-based media, the consolidated annotations, and the links between the time-based medium and the corresponding aggregated annotations.

41. The method as in claim 39, further comprising the step of displaying the consolidated annotations.

42. The method as in claim 39, further comprising the step of providing as output the consolidated annotations.
